(19) United States
(12) Patent Application Publication
(10) Pub. No.: US 2019/0234432 A1
(43) Pub. Date: Aug. 1, 2019

(54) HYDRAULIC FLANGE

(71) Applicant: SKF Lubrication Systems Germany GmbH, Walldorf (DE)

(72) Inventors: Marco Witt, Berlin (DE); Juergen Kreutzkaemper, Waibstadt-Daisbach (DE); Richard Lindemann, Falkensee (DE)

(21) Appl. No.: 16/120,730

(22) Filed: Sep. 4, 2018

(30) Foreign Application Priority Data
Jan. 26, 2018 (DE) 102018201207.5

(51) Int. Cl. F15B 13/08; F04B 23/02

(52) U.S. Cl. CPC F15B 13/0814; F15B 13/0835; F04B 23/02

(57) ABSTRACT

A hydraulic flange for connecting a drive device to a fluid reservoir includes a first hydraulic port and a second hydraulic port, and the first hydraulic port includes a radially inwardly extending, circumferential wall forming a shoulder therein that divides the first hydraulic port into an axially outer portion having a first diameter and an axially inner portion having a second diameter. The axially outer portion is configured to receive a first annular seal element having a third diameter and the axially inner portion is configured to receive a second annular seal element having a fourth diameter.

### CROSS-REFERENCE

This application claims priority to German patent application no. 10 2018 201 207.5 filed on Jan. 26, 2018, the contents of which are fully incorporated herein by reference.

### TECHNOLOGICAL FIELD

The present invention relates to a hydraulic flange for connecting a drive device to a fluid reservoir which hydraulic flange includes at least one hydraulic port.

### BACKGROUND

Drive devices such as, for example, electric drive motors can be connected to a fluid reservoir in order to pump fluids, for example, a hydraulic fluid or a lubricant, from the reservoir to further devices. Here hydraulic flanges are used that connect the drive device, which includes a pump device, to the reservoir. Such a hydraulic flange additionally includes at least one hydraulic port, via which the fluid is delivered to further devices. In previous hydraulic flanges it is necessary to specifically adapt the screw elements, by which hydraulic lines of the further devices are connected to the fluid reservoir and the drive device, to the hydraulic flange.

### SUMMARY

One aspect of the present disclosure is to provide a hydraulic flange, using which hydraulic lines can be connected to drive devices in a flexible and simple manner.

In order to pump a fluid, for example, a hydraulic fluid or a lubricant, from a reservoir to further devices by a drive device, on the one hand the drive device must be connected to the fluid reservoir, and on the other hand the fluid reservoir must be connected to hydraulic lines that lead to the further devices. For this purpose a hydraulic flange is used that includes at least one hydraulic port. Here the hydraulic flange connects the fluid reservoir to the drive device and makes possible via the hydraulic port a connecting of the fluid reservoir to the further devices. These further devices can be any devices that require a supply of fluids, for example, a lubricant such as oil.

The hydraulic port includes a radially inner-lying encircling step, wherein the step has a first diameter for receiving a first annular seal element and a second diameter for receiving a second annular seal element. Here “for receiving” a first or a second annular seal element means that the first diameter is suited to receive a first annular seal element and the second diameter is suited to receive a second annular seal element.

The hydraulic port is configured here such that, depending on the seal element used, the seal element is fitted in the first diameter or in the second diameter. The seal elements can be, for example, O-rings, copper seals, or EO-2 seals. The seal elements differ in their function and can be selected depending on the connecting element used for connecting the hydraulic line.

Due to the various diameters in the hydraulic port, the different types of seals, which also differ in their diameter, can be inserted into the hydraulic port. Thus no specific connection- or connecting-elements are required for connecting hydraulic lines that already provide a sealing of the connection. Instead, simple connecting elements can be used, wherein a sealing of the connection between hydraulic flange and hydraulic line is effected via the seal element used. Different types of connecting elements can thus be used for the connecting of the hydraulic lines that interact with different types of seal elements that can be inserted into the hydraulic port.

According to one embodiment the first diameter is greater than the second diameter. Here the first diameter is disposed axially outward and the second diameter axially inward. A transition between the first and the second diameter can in particular be configured as a step. A seal element that corresponds to the first diameter can abut against this step. It can thereby be prevented that the seal element moves inward. Seal elements that require a press fit, such as, for example, O-rings, can be introduced into the hydraulic port up to the second diameter so that the press fit is achieved. Alternatively the transition can be configured conical, wherein the respectively used seal elements can be flexibly inserted into the hydraulic port up to a position that corresponds to the diameter of the seal element.

The hydraulic port can include a radially inner-lying thread. This thread can interact with an external thread of a connecting element for connecting a hydraulic line. The radially inner-lying thread is preferably disposed in the region of the second diameter, wherein the region of the first diameter is thread-free.

Several hydraulic ports can be provided. The hydraulic ports are preferably disposed such that connecting elements screwable into the hydraulic ports have a sufficient distance from each other in the screwed-in state. For example, the connecting elements can be attached to the hydraulic flange using screw connections. These screw connections can have an outer-lying profile. In this case the distance between the hydraulic ports can be selected such that the profiles of the various screw connections do not hinder one another.

According to a further embodiment the hydraulic flange includes a port for receiving a drive-device connection. A central axis of this port can be disposed perpendicular to the central axis of the hydraulic port. The port can include a radially outer-lying circumferential centering edge. The introducing of the drive device connection is simplified by the centering edge since the drive device connection is guided toward the actual port by the centering edge. In order to prevent a bending or breaking-off of the centering edge, this can be supported on the housing edge by radially outwardly extending ribs.

In addition, the hydraulic flange can include a port for connecting to the fluid reservoir. This port can be disposed, for example, opposite to the connection for the drive device.

The hydraulic flange can include a pressure channel that is closable using a closure element. In the manufacturing of the hydraulic flange, the pressure channel is produced from outside by a bore. This bore is closable using the closure element. The closure element can be, for example, an expander that is comprised of a cylinder that includes a ball at one end. If a fluid is located in the pressure channel, for example, hydraulic fluid, force is exerted on the ball and it is pressed into the cylinder, which expands and closes the pressure channel.

According to a further embodiment the hydraulic flange includes a venting opening that is closed by a venting valve. If the pressure through the fluid in the hydraulic flange is too high, the pressure can be drained or reduced via the venting opening. The venting opening is subsequently sealed again by the venting valve. The venting valve can be, for example, a piston slide valve that reacts to pressure. If the pressure in the hydraulic flange is too high, the venting valve opens in order to release a part of the fluid contained in the hydraulic flange, for example, into a relief line that is coupled to the fluid reservoir. If the pressure is sufficiently reduced, the valve is closed again.

Further advantages and advantageous embodiments are specified in the description, the drawings, and the claims. Here in particular the combinations of features specified in the description and in the drawings are purely exemplary, so that the features can also be present individually or combined in other ways.

In the following the invention is described in more detail on the basis of the exemplary embodiments depicted in the drawings. Here the exemplary embodiments and the combinations shown in the exemplary embodiments are purely exemplary and are not intended to define the scope of the invention. This scope is defined solely by the pending claims.

### BRIEF DESCRIPTION OF THE DRAWINGS

FIG. 1 is a perspective view of a hydraulic flange.

FIG. 2 is a sectional perspective view of the hydraulic flange of FIG. 1.

FIG. 3 is a further sectional perspective view of the hydraulic flange of FIG. 1.

FIG. 4 is an enlarged sectional view of a part of the hydraulic flange of FIG. 1.

### DETAILED DESCRIPTION

In the following, identical or functionally equivalent elements are designated by the same reference numbers.

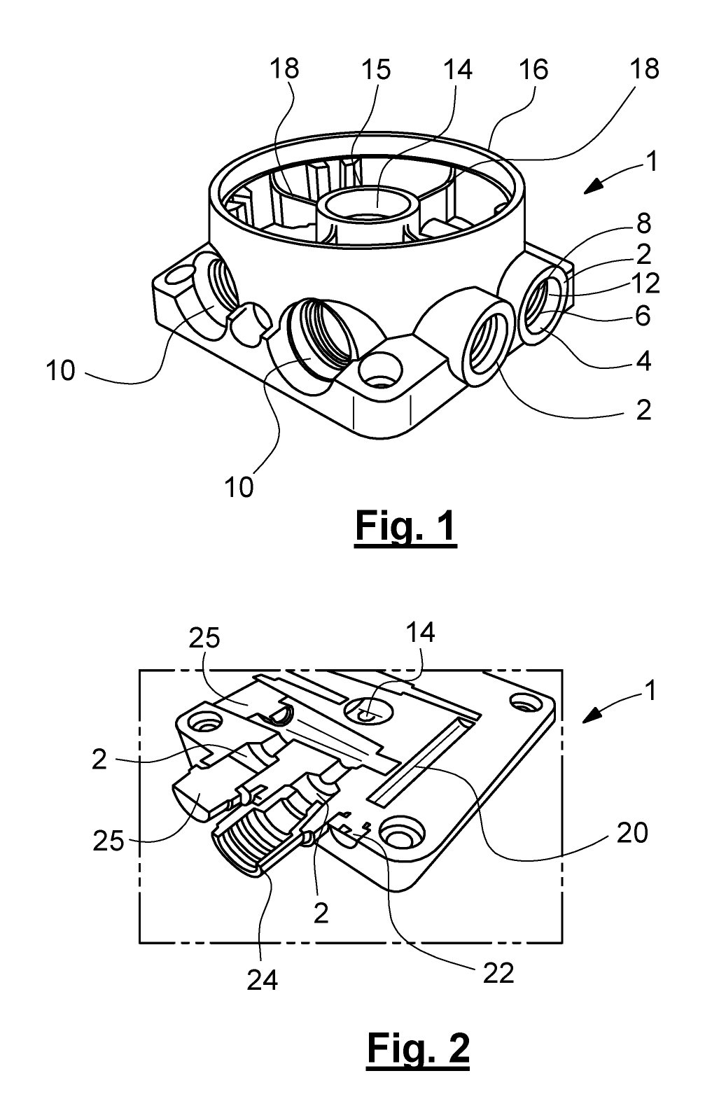

FIG. 1 shows a hydraulic flange 1. This hydraulic flange 1 can be used to connect a drive device (not shown) to a fluid reservoir (not shown). Furthermore, the drive device and the fluid reservoir can be connected via the hydraulic flange 1 to further devices to which the fluid that is located in the fluid reservoir is to be pumped. For this purpose the hydraulic flange 1 includes one or more hydraulic ports 2 to which hydraulic lines can be connected, via which the fluid is directed to the further devices. The drive device can be connected via a connection 14.

As is shown in FIG. 1, the hydraulic ports 2 are disposed with their central axis perpendicular to a central axis of the port 14 for the drive device. In addition, ports (not shown) can be provided via which relief lines can be connected. The fluid can be guided back into the fluid reservoir via such relief lines if, for example, the pressure within the hydraulic flange 1 becomes too high.

The port 14 for the drive device is surrounded by a centering edge 15. The inserting of a connection of the drive device into the port 14 can be simplified by this centering edge 15. In order to support the centering edge 15, it is supported by ribs 18 against a housing edge 16.

The hydraulic ports 2 include a radially inner-lying thread 8. Screw-connection elements can be screwed-in into this thread 8 in order to connect hydraulic lines to the hydraulic flange 1. In order that the screw-connection elements can be simply configured, various seal elements can be inserted into the hydraulic ports 2. Depending on the screw-connection element or function of the seal element these seal elements can be configured differently in their diameter.

The hydraulic ports 2 therefore include a radially inner-lying step 12. This step 12 represents the transition between a first, larger diameter 4 and a second, smaller diameter 6. The step 12 can be configured either as a step or as a conical transition. Here seals that are used in the hydraulic ports 2 can either correspond to the first diameter 4 and abut against the step 12, or can correspond to the second diameter 6. In this way various seals can be used. Simple screw-connection elements can thus be used without special adaptation to the specific intended purpose. Up to now it was necessary to use screw-connection elements that ensure a sealing of the connection between hydraulic line and hydraulic flange 1. This can be omitted here since simple screw-connection elements can be used, wherein the seal is effected by the seal elements that can be adapted to the respective screw-connection element or the required function.

In order to provide a connection between the port 14 for the drive device and the hydraulic ports 2, the hydraulic flange 1 includes an inner-lying pressure channel 20 that connects the various ports. This is shown in FIG. 2.

Here the pressure channel 20 is bored from the outside. This bore is subsequently closed by a closure element, for example, an expander 22. The expander 22 is closed by the fluid in the pressure channel 20. This fluid exerts force on a ball of the expander 22 and presses it into a cylinder of the expander 22. The cylinder expands and closes the pressure channel 20. In order to avoid dead space in the pressure channel 20, a plurality of expanders 22 can also be provided inside the pressure channel 20.

FIG. 2 further shows that a screw-connection element 24 is inserted into one of the hydraulic ports 2. Here the screw-connection element 24 provides the connection between the hydraulic line 1 and a hydraulic line (not shown). The further hydraulic port 2, which is not connected to a hydraulic line, can be sealed by a closure element 25. An escaping of a fluid from the hydraulic flange 1 can thus be prevented.

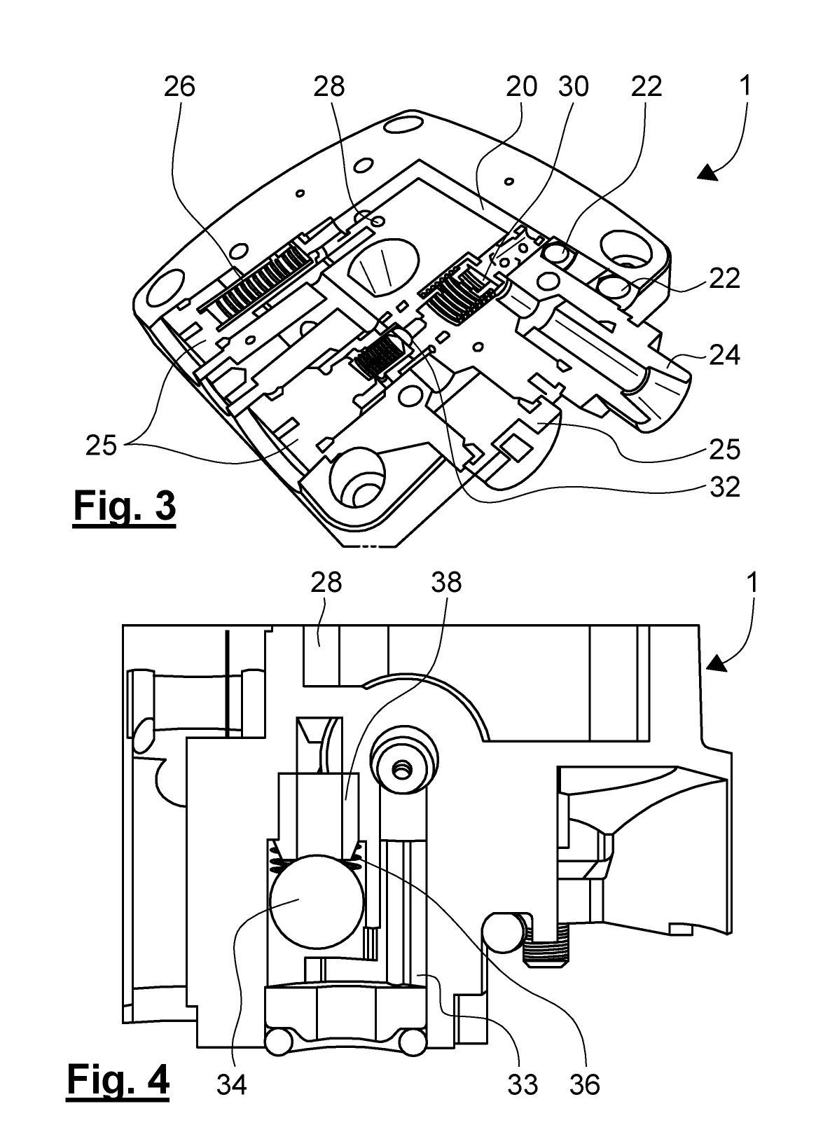

In order to pump the fluid into the screw-connection element 24 and the associated hydraulic line, the pressure channel 20 can include various valves 26, 30, 32, which are depicted in more detail in FIG. 3. These valves are introduced from the outside into the pressure channel 20 via openings or bores 10. In FIG. 1 the openings 10 are provided with threads, but these are only optional and the openings 10 can also be provided without threads.

Firstly a pressure limiting valve 26 can be provided. This can be introduced into the hydraulic flange via one of the openings 10 and secured by a closure element 25. This pressure-limiting valve 26 is configured to maintain the pressure within the pressure channel 20. The pressure can be, for example, 30 bar.

In addition a control valve 30 and a relief valve 32 can be provided. These two valves 30, 32 serve to reduce or increase the pressure in the pressure channel as required. These can also be introduced into the hydraulic flange via one of the openings 10 and secured by a closure element 25.

In order to release pressure from the pressure channel 20, a venting bore 28 is provided. This can be closed by a venting valve 33, which is shown in more detail in FIG. 4.

The venting valve 33 includes a channel 38 that is closed by a ball 34 and a spring 36. If the pressure in the hydraulic flange 1 is too high due to the fluid present, the venting valve 33 opens to release a part of the fluid. If this escapes, for example, via a relief line, the valve 33 is closed again by the ball 34 pressing against the spring 36.

Due to the hydraulic flange proposed herein it is possible to use various seals. In this way simple screw-connection elements can be used for connecting hydraulic lines, since these need not contain any separate seal. Here the seals can be selected and used depending on the screw-connection element used.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved hydraulic flanges.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Hydraulic flange
2 Hydraulic port
4 First diameter
6 Second diameter
8 Thread
10 Opening
12 Step
14 Port
15 Centering edge
16 Housing edge
18 Ribs
20 Pressure channel
22 Closure element
24 Screw-connection element
25 Closure element
26 Pressure-limiting valve
28 Venting bore
30 Control valve
32 Relief valve
33 Venting bore
34 Ball
36 Spring
38 Channel

What is claimed is:

1. A hydraulic flange for connecting a drive device to a fluid reservoir, the hydraulic flange comprising:
a first hydraulic port and a second hydraulic port,
wherein the first hydraulic port includes a radially inwardly extending, circumferential wall forming a shoulder in the first hydraulic port and dividing the first hydraulic port into an axially outer portion having a first diameter and an axially inner portion having a second diameter, and
wherein the axially outer portion is configured to receive a first annular seal element having a third diameter and the axially inner portion is configured to receive a second annular seal element having a fourth diameter.

2. The hydraulic flange according to claim 1, wherein the first diameter is greater than the second diameter.

3. The hydraulic flange according to claim 2, wherein the third diameter is greater than the second diameter.

4. The hydraulic flange according to claim 1, wherein the shoulder is perpendicular to a central axis of the first hydraulic port.

5. The hydraulic flange according to claim 1, wherein the axially inner portion of the first hydraulic port is internally threaded.

6. The hydraulic flange according to claim 1, including an input port for receiving a drive-device connection, wherein the input port includes a radially outer-lying circumferential centering edge that is supported on a housing edge by radially outwardly extending ribs.

7. The hydraulic flange according to claim 1, including a pressure channel and a closure element for closing the pressure channel.

8. The hydraulic flange according to claim 1, including a venting opening and a venting valve for closing the venting opening.

9. The hydraulic flange according to claim 3,
wherein the shoulder is perpendicular to a central axis of the first hydraulic port,
wherein the axially inner portion of the first hydraulic port is internally threaded, and
including an input port for receiving a drive-device connection, wherein the input port includes a radially outer-lying circumferential centering edge that is supported on a housing edge by radially outwardly extending ribs.

10. The hydraulic flange according to claim 9, including a pressure channel and a closure element for closing the pressure channel and including a venting opening and a venting valve for closing the venting opening.
